(19) United States
(12) Patent Application Publication
(10) Pub. No.: US 2023/0396300 A1
(43) Pub. Date: Dec. 7, 2023

(54) REPORTING CHANNEL STATE INFORMATION FOR HIGH SPEED DEVICES

(71) Applicant: Lenovo (Singapore) Pte. Ltd., New Tech Park (SG)

(72) Inventors: Ahmed Monier Ibrahim Saleh Hindy, Aurora, IL (US); Vijay Nangia, Woodridge, IL (US); Majid Ghanbarinejad, Chicago, IL (US)

(21) Appl. No.: 18/246,313

(22) PCT Filed: Sep. 21, 2021
(86) PCT No.: PCT/IB2021/058604

§ 371 Date: Mar. 22, 2023

Related U.S. Application Data
(60) Provisional application No. 63/081,848, filed on Sep. 22, 2020.

(51) Int. Cl. H04B 7/06; H04B 7/0456; H04L 5/00

(52) U.S. Cl. CPC H04B 7/0626; H04B 7/0478; H04B 7/0639; H04L 5/0048; H04B 7/0641

(57) ABSTRACT

Apparatuses, methods, and systems are disclosed for reporting channel state information for high speed devices. One method (800) includes receiving (802) an indication of a high-speed channel state information framework. The method (800) includes receiving (804) a channel state information reporting configuration corresponding to high-speed devices. The method (800) includes receiving (806) channel state information reference signal resources based on a channel state information reference signal resource configuration. The method (800) includes generating (808) at least one channel state information report based on at least one measurement, at least one configuration, and/or at least one indication according to the channel state information reporting configuration. The at least one channel state information report includes a first part and a second part, and the second part includes at least one group. The method (800) includes reporting (810) the at least one channel state information report to a network.

### CROSS-REFERENCE TO RELATED APPLICATIONS

This application claims priority to U.S. patent application Ser. No. 63/081,848 entitled “APPARATUSES, METHODS, AND SYSTEMS FOR CSI FRAMEWORK ENHANCEMENTS FOR HIGH DOPPLER SCENARIOS” and filed on Sep. 22, 2020 for Ahmed Monier Ibrahim Saleh Hindy, which is incorporated herein by reference in its entirety.

### FIELD

The subject matter disclosed herein relates generally to wireless communications and more particularly relates to reporting channel state information for high speed devices.

### BACKGROUND

In certain wireless communications networks, channel state information may be reported. A channel state information report configuration may be insufficient for high speed devices.

### BRIEF SUMMARY

Methods for reporting channel state information for high speed devices are disclosed. Apparatuses and systems also perform the functions of the methods. One embodiment of a method includes receiving, at a user equipment, an indication of a high-speed channel state information framework. In some embodiments, the method includes receiving a channel state information reporting configuration corresponding to high-speed devices. A channel state information reporting behavior corresponding to the channel state information reporting configuration has a first specific time pattern. In certain embodiments, the method includes receiving channel state information reference signal resources based on a channel state information reference signal resource configuration. A channel state information reference signal transmission corresponding to the channel state information reference signal resource configuration has a second specific time pattern. In various embodiments, the method includes generating at least one channel state information report based on at least one measurement, at least one configuration, at least one indication, or some combination thereof according to the channel state information reporting configuration. In some embodiments, the method includes reporting the at least one channel state information report to a network.

One apparatus for reporting channel state information for high speed devices includes a user equipment. In some embodiments, the apparatus includes a receiver that: receives an indication of a high-speed channel state information framework; receives a channel state information reporting configuration corresponding to high-speed devices, wherein a channel state information reporting behavior corresponding to the channel state information reporting configuration has a first specific time pattern; and receives channel state information reference signal resources based on a channel state information reference signal resource configuration. A channel state information reference signal transmission corresponding to the channel state information reference signal resource configuration has a second specific time pattern. In various embodiments, the apparatus includes a processor that generates at least one channel state information report based on at least one measurement, at least one configuration, at least one indication, or some combination thereof according to the channel state information reporting configuration. In certain embodiments, the apparatus includes a transmitter that reports the at least one channel state information report to a network.

Another embodiment of a method for reporting channel state information for high speed devices includes receiving, at a user equipment, an indication of a high-speed channel state information framework. In some embodiments, the method includes receiving a channel state information reporting configuration corresponding to high-speed devices. In certain embodiments, the method includes receiving channel state information reference signal resources based on a channel state information reference signal resource configuration. In various embodiments, the method includes generating at least one channel state information report based on at least one measurement, at least one configuration, at least one indication, or some combination thereof according to the channel state information reporting configuration. The at least one channel state information report includes a first part and a second part, and the second part includes at least one group. The at least one channel state information report is classified into two or more report types. In some embodiments, the method includes reporting the at least one channel state information report to a network.

Another apparatus for reporting channel state information for high speed devices includes a user equipment. In some embodiments, the apparatus includes a receiver that: receives an indication of a high-speed channel state information framework; receives a channel state information reporting configuration corresponding to high-speed devices; and receives channel state information reference signal resources based on a channel state information reference signal resource configuration. In various embodiments, the apparatus includes a processor that generates at least one channel state information report based on at least one measurement, at least one configuration, at least one indication, or some combination thereof according to the channel state information reporting configuration. The at least one channel state information report includes a first part and a second part, and the second part includes at least one group. The at least one channel state information report is classified into two or more report types. In certain embodiments, the apparatus includes a transmitter that reports the at least one channel state information report to a network.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reporting channel state information for high speed devices;

FIG. 2 is a schematic block diagram illustrating one embodiment of an apparatus that may be used for reporting channel state information for high speed devices;

FIG. 3 is a schematic block diagram illustrating one embodiment of an apparatus that may be used for reporting channel state information for high speed devices;

FIG. 4 is a diagram showing one embodiment of ASN.1 code for a second CSI report and/or resource setup;

FIG. 5 is a diagram showing one embodiment of ASN.1 code for a third CSI report and/or resource setup;

FIGS. 6A, 6B, and 6C are a diagram showing one embodiment of ASN.1 code for a first CSI report structure;

FIG. 7 is a flow chart diagram illustrating one embodiment of a method for reporting channel state information for high speed devices; and

FIG. 8 is a flow chart diagram illustrating another embodiment of a method for reporting channel state information for high speed devices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

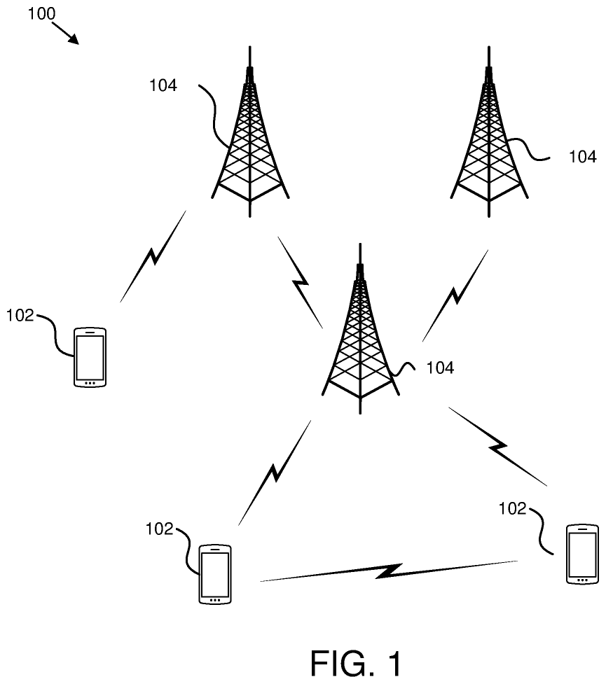

FIG. 1 depicts an embodiment of a wireless communication system 100 for reporting channel state information for high speed devices. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive an indication of a high-speed channel state information framework. In some embodiments, the remote unit 102 may receive a channel state information reporting configuration corresponding to high-speed devices. A channel state information reporting behavior corresponding to the channel state information reporting configuration has a first specific time pattern. In certain embodiments, the remote unit 102 may receive channel state information reference signal resources based on a channel state information reference signal resource configuration. A channel state information reference signal transmission corresponding to the channel state information reference signal resource configuration has a second specific time pattern. In various embodiments, the remote unit 102 may generate at least one channel state information report based on at least one measurement, at least one configuration, at least one indication, or some combination thereof according to the channel state information reporting configuration. In some embodiments, the remote unit 102 may report the at least one channel state information report to a network. Accordingly, the remote unit 102 may be used for reporting channel state information for high speed devices.

In certain embodiments, a remote unit 102 may receive an indication of a high-speed channel state information framework. In some embodiments, the remote unit 102 may receive a channel state information reporting configuration corresponding to high-speed devices. In certain embodiments, the remote unit 102 may receive channel state information reference signal resources based on a channel state information reference signal resource configuration. In various embodiments, the remote unit 102 may generate at least one channel state information report based on at least one measurement, at least one configuration, at least one indication, or some combination thereof according to the channel state information reporting configuration. The at least one channel state information report includes a first part and a second part, and the second part includes at least one group. The at least one channel state information report is classified into two or more report types. In some embodiments, the remote unit 102 may report the at least one channel state information report to a network. Accordingly, the remote unit 102 may be used for reporting channel state information for high speed devices.

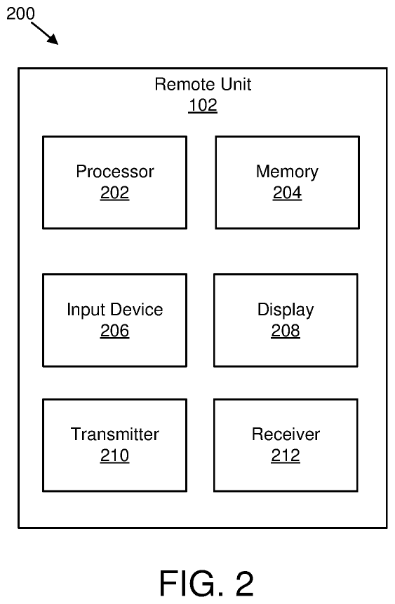

FIG. 2 depicts one embodiment of an apparatus 200 that may be used for reporting channel state information for high speed devices. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives an indication of a high-speed channel state information framework; receives a channel state information reporting configuration corresponding to high-speed devices, wherein a channel state information reporting behavior corresponding to the channel state information reporting configuration has a first specific time pattern; and receives channel state information reference signal resources based on a channel state information reference signal resource configuration. A channel state information reference signal transmission corresponding to the channel state information reference signal resource configuration has a second specific time pattern. In various embodiments, the processor 202 generates at least one channel state information report based on at least one measurement, at least one configuration, at least one indication, or some combination thereof according to the channel state information reporting configuration. In certain embodiments, the transmitter 210 reports the at least one channel state information report to a network.

In some embodiments, the receiver 212: receives an indication of a high-speed channel state information framework; receives a channel state information reporting configuration corresponding to high-speed devices; and receives channel state information reference signal resources based on a channel state information reference signal resource configuration. In various embodiments, the processor 202 generates at least one channel state information report based on at least one measurement, at least one configuration, at least one indication, or some combination thereof according to the channel state information reporting configuration. The at least one channel state information report includes a first part and a second part, and the second part includes at least one group. The at least one channel state information report is classified into two or more report types. In certain embodiments, the transmitter 210 reports the at least one channel state information report to a network.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

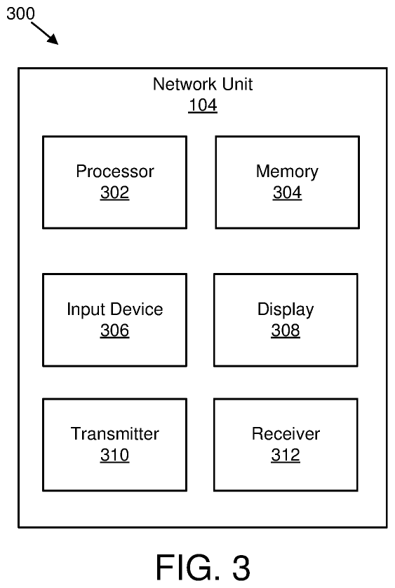

FIG. 3 depicts one embodiment of an apparatus 300 that may be used for reporting channel state information for high speed devices. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, such as for third generation partnership program (“3GPP”) new radio (“NR”), channel state information (“CSI”) feedback may be reported by a user equipment (“UE”) to a network, where the CSI feedback may take multiple forms based on the CSI feedback report size, time, and frequency granularity. In some embodiments, such as in NR, a high-resolution CSI feedback report (e.g., Type-II) may be used, where the frequency granularity of the CSI feedback may be indirectly parametrized. In various embodiments, a UE speed may be relatively high (e.g., up to 500 km/h). Such embodiments may maintain a good quality of service and have a modified CSI framework that includes measurement and reporting.

In some embodiments, CSI measurement may be enabled and reporting may be suitable for high-Doppler scenarios, where a UE speed is relatively high. In such embodiments, CSI reference signal (“RS”) (“CSI-RS”) configuration enhancements may help capture a time-varying channel under high Doppler shift and/or spread conditions. Both a CSI reporting configuration and a CSI resource configuration may be modified to improve a quality of a channel estimation, while maintaining a reasonable tradeoff with the CSI feedback overhead and the network and/or UE complexity. In various embodiments, activation and/or deactivation of semi-persistent-like CSI-RS resource configurations may be used. In certain embodiments, modifications to a CSI feedback report content may be made so that the CSI fed back for high Doppler UEs may be optimized in both quantity and quality manners. In some embodiments, there may be methods for toggling between CSI resource and report configurations for conventional scenarios as well as high-Doppler scenarios, where proper indication (e.g., implicit or explicit) to the UE of the high Doppler mode for CSI measurement and/or reporting may be used.

As may be appreciated, one or more elements or features from one or more of the described embodiments may be combined (e.g., for CSI measurement, feedback generation, and/or reporting which may reduce an overall CSI feedback overhead).

In various embodiments, a UE is configured by higher layers with one or more CSI report configuration reporting settings for CSI reporting, one or more CSI resource configuration resource settings for CSI measurement, and/or one or two lists of trigger states (e.g., given by the higher layer parameters CSI-AperiodicTriggerStateList and CSI-SemiPersistentOnPUSCH-TriggerStateList). Each trigger state in CSI-AperiodicTriggerStateList may contain a list of a subset of associated CSI report configurations indicating resource set identifiers for a channel and/or for interference. Each trigger state in CSI-SemiPersistentOnPUSCH-TriggerStateList may contain one or more associated CSI report configurations.

In certain embodiments, CSI measurement and reporting for high speed devices may be indicated via introducing a new higher layer parameter in one or more CSI report configuration report settings. In one example, the new higher-layer parameter is named HighSpeedCSlEnabled, and if configured in the CSI report setting, the CSI-RS transmission and CSI feedback reporting may follow the CSI measurement and reporting for the high-speed framework.

In some embodiments, additional values for a higher layer parameter reportQuantity representing a CSI report quantity in one or more CSI report configuration CSI report settings may be used to indicate a CSI-RS transmission and CSI feedback reporting may follow the CSI measurement and reporting for the high-speed framework. In one example, additional reporting quantities with Doppler indication (e.g., Doppler indicator (“DI”), high-speed indicator (“HSI”)) may be used. For instance, additional values of the CSI report quantity may take on the form ‘cri-RI-PMI-CQI-DI’, compared with ‘cri-RI-PMI-CQI’ for frameworks not including high-speed CSI measurement and reporting.

In various embodiments, other indications of CSI measurement and reporting under high-speed framework are not precluded, for example via downlink control information (“DCI”) triggering, medium access control (“MAC”) control element (“CE”) signaling or UE-assisted indication.

In certain embodiments, different setups of CSI report and resource configurations may be used. It should be noted that a subset of one setup, or a combination of one or more setups (e.g., including combination of subsets of one or more setups) may be used.

In one embodiment of a first CSI report and/or resource setup, a UE is configured with at least two CSI report settings CSI report configuration (i.e., CSI-ReportConfig), each linked with at least one CSI resource configuration (i.e., CSI-ResourceConfig) resource setting, where one CSI resource setting linked to the first CSI report setting may be configured with the higher-layer parameter resourceType set to the value resourceTypeA, and one CSI resource setting linked to the other CSI report setting may be configured with the higher-layer parameter resourceType set to resourceTypeB. Each of resourceTypeA and resourceTypeB represents one value in the set of one or more values including at least {‘periodic’, ‘aperiodic’, ‘semiPersistent’}. It should be noted that resourceTypeA and resourceTypeB may refer to different values, e.g., resourceTypeA may be ‘aperiodic’ and resourceTypeB may be ‘semiPersistent’. Each of the CSI resource settings may be configured with one or more CSI-RS resource sets. The time-domain behavior of the two CSI report settings may be indicated via the higher-layer parameter reportConfigType set to reportTypeA and reportTypeB, respectively, where each of reportTypeA and reportTypeB represent one value in the set of one or more values including at least {‘periodic’, ‘aperiodic’, ‘semiPersistentOnPUSCH’, ‘semiPersistentonPUCCH’}. It should be noted that reportTypeA and reportTypeB may refer to different values, e.g., reportTypeA may be ‘aperiodic’ and reportTypeB may be semiPersistentOnPUSCH’. Also, it should be noted that one CSI-ReportConfig report setting may be triggered by the inclusion of its identification number in the other CSI-ReportConfig report setting, and, in some embodiments, the UE may be configured with a higher-layer parameter, MAC CE signaling, or a UE-fed back indicator that indicates CSI measurement and reporting under high speed.

In one example, a UE is configured with two CSI report settings CSI-ReportConfig, each linked with one CSI resource setting CSI-ResourceConfig, where the CSI resource setting linked to the first CSI report setting is configured with the higher-layer parameter resourceType set to the ‘aperiodic’, and the CSI resource setting linked to the other CSI report setting is configured with the higher-layer parameter resourceType set to ‘semiPersistent’. Each of the CSI resource settings is configured with one CSI-RS resource set. The time-domain behavior of the two CSI report settings is indicated via the higher-layer parameter reportConfigType set to ‘aperiodic’ and ‘semiPersistentOnPUSCH’, respectively. The second CSI report setting is triggered within the first CSI report setting, where the identification number of the former report setting is included in the content of the latter report setting.

In another embodiment of a second CSI report and/or resource setup, a UE is configured with at least one CSI report setting CSI-ReportConfig linked with at least two CSI resource settings CSI-ResourceConfig. The first CSI resource setting may be configured with the higher-layer parameter resourceType set to resourceTypeA, and the second CSI resource setting may be configured with the higher-layer parameter resourceType set to resourceTypeB, where each of resourceTypeA and resourceTypeB represents one value in the set of one or more values including at least {‘periodic’, ‘aperiodic’, ‘semiPersistent’}. In various embodiments, one codepoint of the CSI resource configuration identifier (“ID”) may refer to two CSI resource configurations. It should be noted that the time domain behaviors of both resource settings, i.e., the value of resourceTypeA and resourceTypeB, may be the same, except if the UE is configured with a higher-layer parameter, MAC CE signaling, or a UE-fed back indicator, that indicates CSI measurement and reporting under high speed. Each of the CSI resource settings may be configured with one or more CSI-RS resource sets. The time-domain behavior of the CSI report setting may be indicated via the higher-layer parameter reportConfigType set to reportTypeA, which represents one value in the set of one or more values including at least {‘periodic’, ‘aperiodic’, ‘semiPersistentOnPUSCH’, ‘semiPersistentonPUCCH’}. It should be noted that more than one CSI resource setting for non-zero power (“NZP”) CSI-RS resource for channel measurement, more than one CSI resource setting for NZP CSI-RS resource for interference measurement, and/or more than one CSI interference measurement (“IM”) (“CSI-IM”) resource for interference measurement may be configured within one CSI resource setting.

In one example, a UE is configured with one CSI report setting CSI-ReportConfig linked with two CSI resource settings CSI-ResourceConfig. The first CSI resource setting is configured with the higher-layer parameter resourceType set to ‘aperiodic’, and the second CSI resource setting is configured with the higher-layer parameter resourceType set to ‘semiPersistent’, with the configuration of the higher-layer parameter HighSpeedCSlenabled in the CSI report setting. Each of the CSI resource settings is configured with one CSI-RS resource set. The time-domain behavior of the CSI report may be indicated via the higher-layer parameter reportConfigType set to ‘semiPersistentOnPUSCH’. Two CSI resource settings for NZP CSI-RS resource for channel measurement (e.g., resourcesForChannelMeasurement and resourcesForChannellMeasurement), one CSI resource setting for NZP CSI-RS resource for interference measurement (e.g., nzp-CSI-RS-ResourcesForinterference), and one CSI-IM resource for interference measurement (e.g., csi-IM-ResourcesForinterference) may be configured within the CSI resource setting.

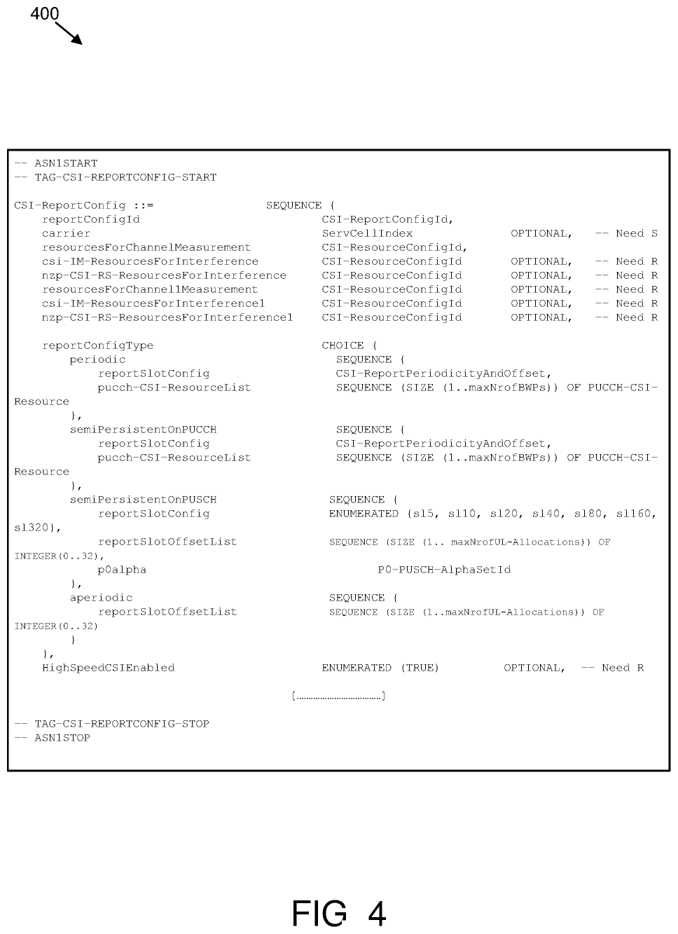

An example of abstract syntax notation (“ASN.1”) code that corresponds to this setup is provided in FIG. 4 for the CSI-ReportConfig report setting information element (“IE”). Specifically, FIG. 4 is a diagram 400 showing one embodiment of ASN.1 code for the second CSI report and/or resource setup.

In yet another embodiment of a third CSI report and/or resource setup, a UE is configured with at least one CSI report setting CSI-ReportConfig linked with at least one CSI resource setting CSI-ResourceConfig, where the CSI resource setting may be configured with one higher-layer parameter resourceType. One codepoint refers to two values resourceTypeA and resourceTypeB, or two higher-layer parameters referring to the time-domain behavior resourceType (e.g., resourceType and resourceType1) are configured with the values resourceTypeA and resourceTypeB, respectively. Each of resourceTypeA and resourceTypeB represents one value in a set of one or more values including at least {‘periodic’, ‘aperiodic’, ‘semiPersistent’}. The time domain behaviors of both resource settings, i.e., the value of resourceTypeA and resourceTypeB, may be the same. It should be noted that only one value for the higher-layer parameter resourceType may be configured in a CSI resource setting, except if the UE is configured with a higher-layer parameter, MAC CE signaling, or a UE-fed back indicator, that indicates CSI measurement and reporting under high speed. Each of the CSI resource settings is configured with one or more CSI-RS resource sets. The time-domain behavior of the CSI report setting may be indicated via the higher-layer parameter reportConfigType set to reportTypeA, which represents one value in the set of one or more values including at least {‘periodic’, ‘aperiodic’, ‘semiPersistentOnPUSCH’, ‘semiPersistentonPUCCH’}.

In one example, a UE is configured with one CSI report setting CSI-ReportConfig linked with one CSI resource setting CSI-ResourceConfig. The CSI resource setting is configured with the higher-layer parameter resourceType set to ‘aperiodic’, and a second higher-layer parameter resourceType1 set to ‘semiPersistent’, with the configuration of the higher-layer parameter HighSpeedCSlenabled in the CSI report setting. The CSI resource setting may be configured with one CSI-RS resource set. The time-domain behavior of the CSI report may be indicated via the higher-layer parameter reportConfigType set to ‘semiPersistentOnPUSCH’.

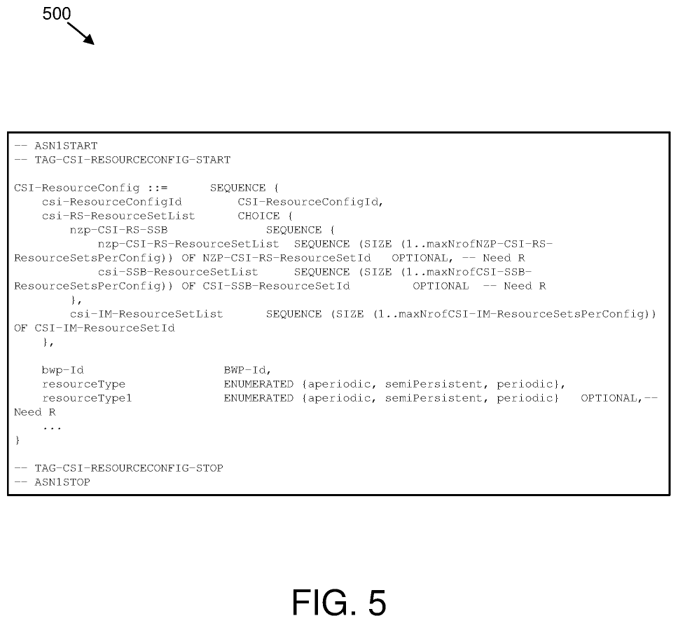

An example of the ASN.1 code that corresponds to this setup is provided in Figure for the CSI-ResourceConfig resource setting IE. Specifically, FIG. 5 is a diagram 500 showing one embodiment of ASN.1 code for a third CSI report and/or resource setup.

In another embodiment of a fourth CSI report and/or resource setup, a UE is configured with at least one CSI report setting CSI-ReportConfig linked with at least one CSI resource setting CSI-ResourceConfig, where the CSI resource setting may be configured with a higher-layer parameter resourceType configured with a value resourceTypeA, which takes on one value in the set of one or more values including at least {‘periodic’, ‘aperiodic’, ‘semiPersistent’}. It should be noted that adding one or more additional values in the set of the one or more values representing resourceTypeA is not precluded, which may imply non-uniform time gaps between subsequent CSI-RS resource transmissions. Moreover, it should be noted that the one or more additional values in the set of the one or more values representing resourceTypeA may not be configured, except if the UE is configured with a higher-layer parameter, MAC CE signaling, or a UE-fed back indicator, that indicates CSI measurement and reporting under high speed. The CSI resource setting may be configured with one or more CSI-RS resource sets. The time-domain behavior of the CSI report setting may be indicated via the higher-layer parameter reportConfigType set to reportTypeA, which represents one value in the set of one or more values including at least {‘periodic’, ‘aperiodic’, ‘semiPersistentOnPUSCH’, ‘semiPersistentonPUCCH’}. It should be noted that adding one or more additional values in the set of the one or more values representing reportTypeA is not precluded, which may imply non-uniform time gaps between subsequent CSI report transmissions. Further, it should be noted that the one or more additional values in the set of the one or more values representing reportTypeA may not be configured, except if the UE is configured with a higher-layer parameter, MAC CE signaling, or a UE-fed back indicator, that represent CSI measurement and reporting under high speed.

In one example, a UE is configured with one CSI report setting CSI-ReportConfig linked with one CSI resource setting CSI-ResourceConfig. The CSI resource setting is configured with the higher-layer parameter resourceType set to ‘Hybrid’. The CSI resource setting is configured with one CSI-RS resource set. The time-domain behavior of the CSI report is indicated via the higher-layer parameter reportConfigType set to ‘HybridOnPUSCH’. The higher-layer parameter HighSpeedCSlenabled is configured in the CSI report setting.

In certain embodiments, additional values (e.g., other than ‘periodic’, ‘aperiodic’, ‘semi-persistent’) may be used for the higher-layer parameter resourceType for CSI-ResourceConfig (e.g., ‘Hybrid’), where the pattern of the time-domain behavior of the CSI resource setting is set via a pre-determined rule, via DCI triggering, via MAC CE, or via UE feedback (e.g., sent at slots n+k1, n+k2, . . . , n+ks, where k1<k2< . . . <ks for s consecutive CSI-RS transmissions for the value of s). For one or more of the CSI-RS resource set lists, the CSI-RS configuration may not be the same across subsequent transmissions.

In some embodiments, additional values (e.g., other than ‘periodic’, ‘aperiodic’, ‘semiPersistentOnPUSCH’, ‘semiPersistentOnPUCCH’) may be used for the higher-layer parameter reporType for CSI-ReportConfig (e.g., ‘HybridOnPUSCH’), where the pattern of the time-domain behavior of the CSI report setting is set via a pre-determined rule, via DCI triggering, via MAC CE, or via UE feedback (e.g., sent at slots n+k1, n+k2, . . . , n+ks), where k1<k2< . . . <ks for s consecutive CSI report transmissions). One or more of the codebook type, the report quantity, the channel quality indicator (“CQI”) table, the CQI format indicator and the sub-band size may not be the same across sub-sequent transmissions.

In some embodiments, report settings and resource settings under CSI measurement and reporting for high-speed users may be used as discussed herein. Moreover, other setups for CSI measurement and reporting (e.g., CSI report settings and CSI resource settings) may be used for any embodiments described herein.

In various embodiments, for CSI-RS resource sets associated with resource settings may be configured with the higher-layer parameter resourceType set to ‘semiPersistent’ or a value other than those in the set {‘periodic’, ‘aperiodic’}.

In certain embodiments, activation and/or deactivation commands of a resource setting may exist in standard documents.

In some embodiments, a resource setting is deactivated with a time threshold (e.g., the deactivation may apply starting from the first slot that is after slot n+kNₛₗₒₜ^{subframe,μ} where n is based on the slot index at which the resource setting was activated, μ is the subcarrier spacing (“SCS”) configuration for a physical uplink control channel (“PUCCH”), and k is a positive integer value that is either fixed, higher-layer configured, or indicated by a UE).

In various embodiments, a resource setting may be activated and/or deactivated with the aid of a UE or UE assistance information (e.g., based on one or more indicator values sent from the UE as part of CSI reporting).

In certain embodiments, a resource setting may be activated and/or deactivated with a pre-defined rule (e.g., one or more values of a reported quantity, such as layer 1 (“L1”) reference signal received power (“RSPR”) (“L1-RSRP”), L1 signal to interference and noise ratio (“SINR”) (“L1-SINR”), CQI, rank indicator (“RI”), and/or Doppler-related values reported in prior CSI reports). The pre-defined rule may take into account a relative value of one or more metrics over time (e.g., Δ=CQI(n+k)−CQI(n)), where n and k are positive integer values, and CQI(n) represents the value of the CQI reported at a slot index n.

In some embodiments, a resource setting is deactivated if a UE is configured with a report setting deactivation, wherein the resource setting is configured within a report setting.

In various embodiments, report settings may be configured with a higher-layer parameter reportConfigType set to ‘semiPersistentOnPUSCH’, ‘semiPersistentOnPUCCH’ or a value other than those in the set {‘periodic’, ‘aperiodic’}.

In certain embodiments, a report setting is deactivated with a time threshold (e.g., the deactivation may apply starting from the first slot that is after slot n+ₛₗₒₜ^{subframe,μ} where n is based on the slot index at which the report setting was activated, μ is the SCS configuration for the PUCCH, and k is a positive integer value that is either fixed, higher-layer configured, or indicated by the UE).

In some embodiments, a report setting may be activated and/or deactivated with the aid of a UE or UE assistance information (e.g., based on one or more indicator values sent from the UE as part of CSI reporting).

In various embodiments, a report setting is activated and/or deactivated with a pre-defined rule (e.g., one or more of the values of a reported quantity, such as L1-RSRP, L1-SINR, CQI, RI, Doppler-related values reported in the prior CSI reports). The pre-defined rule may take into account a relative value of one or more metrics over time (e.g., Δ=CQI(n+k)−CQI(n), where n, k are positive integer values, and CQI(n) represents the value of the CQI reported at a slot index n).

In certain embodiments, a report setting is deactivated if a UE is configured with a resource setting deactivation, and the resource setting has been configured within the report setting.

In some embodiments, CSI reporting may be event-based CSI feedback. For example, with semi-persistent CSI reporting (e.g., on physical uplink shared channel (“PUCCH”) or PUCCH), the UE may skip CSI reporting if an event is not triggered. The event may be triggered if a change in one or more values of metrics (e.g., L1-RSRP, L1-SINR, CQI, RI, Doppler-related values) meets a threshold. The threshold may be configured by higher layers (e.g., received a configuration from a base station) or predefined (e.g., in a specification).

In various embodiments, a first CSI report setting may activate a second CSI report setting. For example, a first CSI report setting may be an aperiodic CSI report which may trigger or activate a second CSI report setting comprising semi-persistent CSI reporting. In certain embodiments, a first CSI report setting may be a semi-persistent CSI report activated by receiving an activation command (e.g., MAC-CE) or receiving an activation DCI (e.g., DCI with a cyclic redundancy cycle (“CRC”) scrambled with semi persistent (“SP”) CSI radio network temporary identifier (“RNTI”) (“SP-CSI-RNTI”)) which may trigger a second CSI report setting including aperiodic CSI reporting. The trigger of the second CSI report setting may be indicated in the activation command or the activation DCI associated with the first CSI report setting. In one example, the aperiodic CSI report is transmitted first by the UE followed by the semi-persistent reporting. The timing of the semi-persistent CSI report may be based on the timing of the aperiodic CSI report (e.g., if the aperiodic CSI report is sent in slot n, the semi-persistent CSI report with periodicity p starts in slot n+p). The semi-persistent CSI report may be based or conditioned on the CSI report indicated in the aperiodic CSI report (e.g., semi-persistent CSI report may be a differential CSI report whose reported elements depend on the values reported in the aperiodic CSI report).

In some embodiments, under the CSI measurement and reporting framework for high-speed users, it may be beneficial for a UE to feedback different CSI structures across time, whether the UE is configured with one or more report settings. Without loss of generality, the CSI feedback reports may be classified into two report types (the CSI feedback reports may be classified to more than two report types). The report types may be considered primary and secondary CSI feedback reports.

In various embodiments, each of a primary and a secondary CSI feedback report represents a full CSI report including one or more of the report quantities CRI, synchronization signal (“SS”) physical broadcast channel (“PBCH”) resource block indicator (“SSBRI”), RI, precoding matrix indicator (“PMI”), CQI, L1, L1-RSRP and L1-SINR. Each CSI feedback report may be represented by a codebook, and may have its own identification number.

In certain embodiments, each CSI feedback report may be decomposed of one or more parts (e.g., Part 1 and Part 2), wherein one or more parts may be further decomposed into one or more groups (e.g., Part 2 Group 0, Part 2 Group 1, and Part 2 Group 2). Each of the parts and/or groups may include a subset of one or more of the report quantities CRI, SSBRI, RI, PMI, CQI, L1, L1-RSRP and L1-SINR. A primary CSI feedback report may represent a combination of one or more parts and one or more groups of the full CSI feedback report, whereas the secondary CSI feedback report may represent the remainder of the parts and groups of the full CSI feedback report that are not included in the primary CSI feedback report. The secondary CSI feedback report may include the combination of parts and groups that are subsequent to those in the primary CSI feedback report. Also, the size of the secondary CSI feedback report may be implied from the primary CSI feedback report.

In one example, the primary CSI feedback report includes one or more of the CRI, SSBRI, L1-RSRP, L1-SINR, RI, CQI, L1, whereas the secondary CSI feedback report includes one or more of the PMI, and a differential value based on the CQI.

In another example, the primary CSI feedback report includes one or more of the CRI, SSBRI, L1-RSRP, L1-SINR, RI, CQI, L1, and a fragment of the PMI, whereas the secondary CSI feedback report includes the remaining fragment of the PMI.

In a further example, a full CSI feedback report may be decomposed into three types: a primary, first secondary and second secondary CSI feedback reports. The primary CSI feedback report includes one or more of the CRI, SSBRI, L1-RSRP, L1-SINR, and the first secondary CSI feedback report includes one or more of the RI, CQI, L1, and a fragment of the PMI, and the second secondary CSI feedback report includes the remainder of the PMI.

Other examples of different decompositions of the CSI across the primary and secondary CSI feedback reports may be used.

In some embodiments, Q secondary CSI feedback reports maybe transmitted on PUSCH and/or PUCCH following one primary CSI feedback report, where Q is a positive integer value that is either fixed, higher-layer configured, or indicated by a UE or with UE assistance.

In various embodiments, primary and secondary CSI feedback reports are transmitted with different periodicity (e.g., a number of slots (“M”) after which primary and secondary CSI feedback reports are transmitted, represented by M_{P}, M_{S}, respectively, whose values are either fixed, higher-layer configured, or indicated by the UE). This may also be represented in terms of introducing different periodicity to one or more of each of the CRI, SSBRI, RI, PMI, CQI, L1, L1-RSRP and L1-SINR, whose periodicity can take on the values M_{CRI}, M_{SSBRI}, M_{RI}, M_{PMI}, M_{CQI}, M_{LI}, M_{L1-RSRP}, M_{L1-SINR}, respectively.

In certain embodiments, a secondary CSI feedback report is triggered with an activation and/or deactivation command in a MAC CE or DCI triggering, wherein secondary CSI feedback reports are transmitted as long as the corresponding CSI report configuration is activated, and a primary CSI feedback report is transmitted after the CSI report configuration is deactivated (e.g., after slot n+kNₛₗₒₜ^{subframe,μ} where n is based on the slot index at which the resource setting was activated, μ is the SCS configuration for the PUCCH, and k is a positive integer value that can be either fixed, higher-layer configured, or indicated by a UE).

In some embodiments, different embodiments of CSI report structures may be used and how they map to the one or more report settings may be indicated. As may be appreciated, a subset of one structure, or a combination of one or more structures may be used.

In one embodiment there is a first CSI report structure, at least one or more of an additional cqi-FormatIndicator format indicator, an additional pmi-FormatIndicator format indicator, an additional csi-ReportingBand reporting band, an additional codebookConfig configuration, an additional codebookConfig-r16 configuration, an additional reportQuantity reporting quantity, an additional reportQuantity-r16 reporting quantity, and/or an additional reportFreqConfiguration frequency configuration may be configured for secondary CSI feedback reports. In such an embodiment, two sets (e.g., primary and secondary) of CSI feedback reports are configured in the CSI-ReportConfig report setting.

In one example, the CSI-ReportConfig report setting includes two configuration values for each of the cqi-FormatIndicator CQI format indicator, the reportQuantity reporting quantity, and one configuration value for each of the pmi-FormatIndicator PMI format indicator, the csi-ReportingBand reporting band, the codebookConfig codebook configuration, and the reportFreqConfiguration frequency-domain configuration.

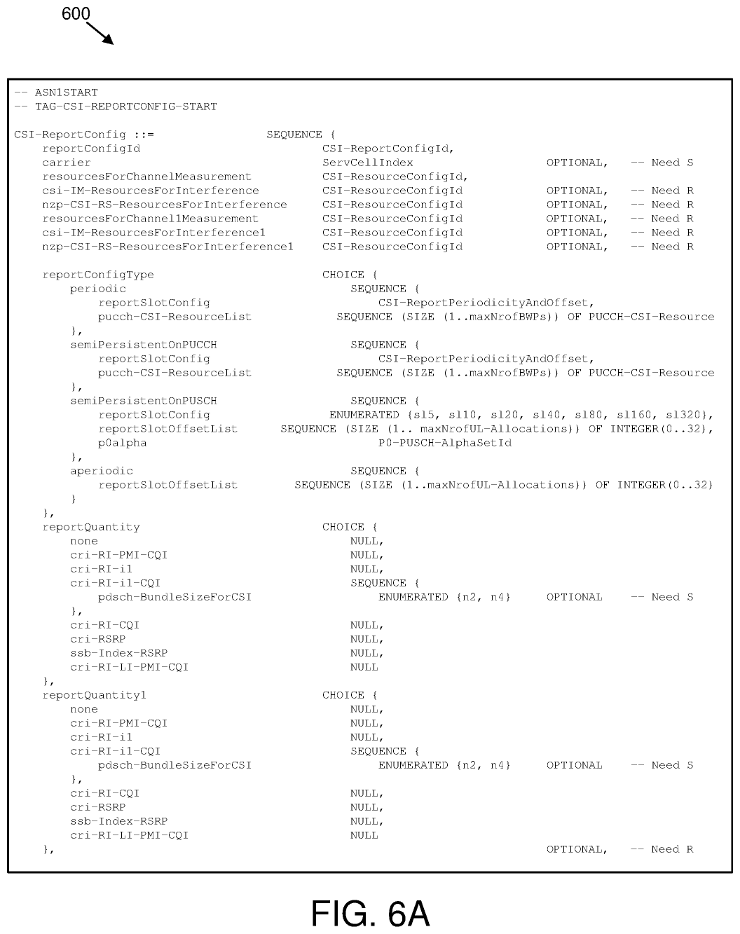

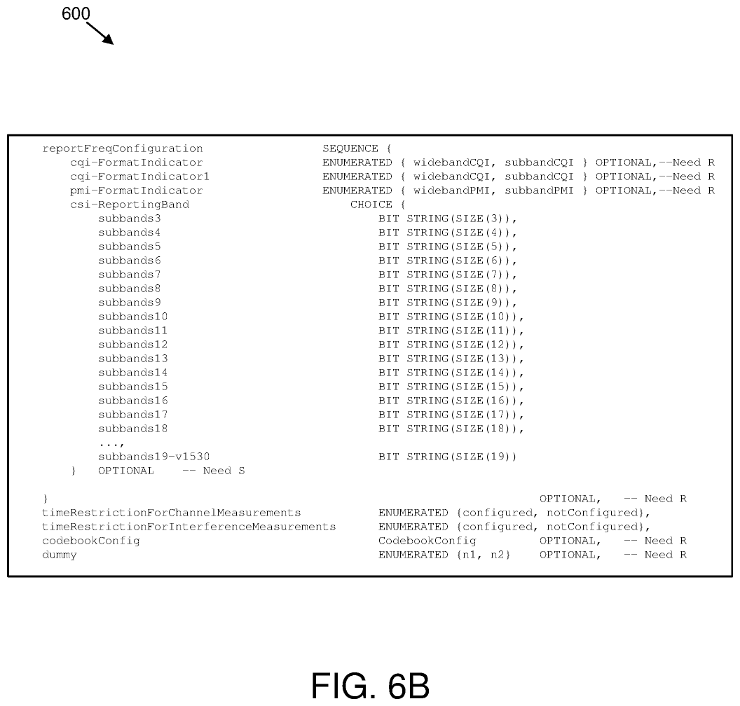

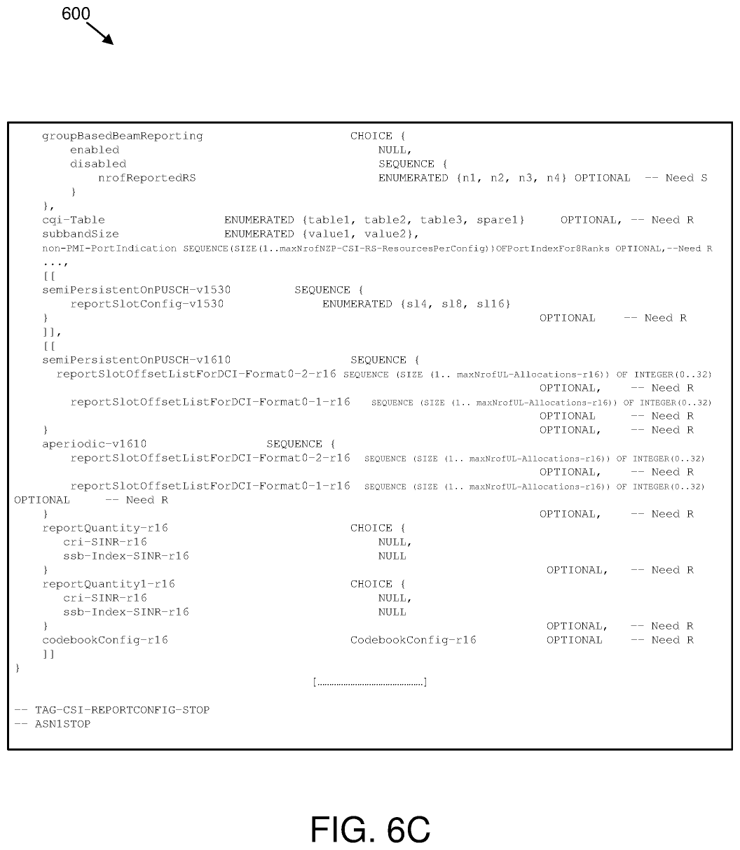

One example of the ASN.1 code that corresponds to the first CSI report structure is illustrated in FIGS. 6A, 6B, and 6C for the CSI-ReportConfig report setting IE. Specifically, FIGS. 6A, 6B, and 6C are a diagram 600 showing one embodiment of ASN.1 code for the first CSI report structure

In another embodiment there is a second CSI report structure. In such an embodiment, at least one or more of the reportQuantity reporting quantity, reportQuantity-r16 reporting quantity, reportFreqConfiguration configuration, cqi-FormatIndicator format indicator, pmi-FormatIndicator format indicator, csi-ReportingBand CSI reporting band, codebookConfig codebook configuration, and/or codebookConfig-r16 Rel. 16 codebook configuration for the secondary CSI feedback reports are set by a rule based on the one or more parameter values configuration for the primary CSI report.

In one example, the CSI-ReportConfig report setting includes only one set of configuration values corresponding to the primary feedback report, whereas the configuration values for the secondary CSI feedback report that are different from the primary CSI feedback report (e.g., the cqi-FormatIdicator CQI format is set to ‘widebandCQI’ by default) irrespective of the CQI format configured in the report setting.

In yet another embodiment there is a third CSI report structure. In such an embodiment, at least one or more of the reportQuantity reporting quantity, reportQuantity-r16 reporting quantity, reportFreqConfiguration configuration, cqi-FormatIndicator format indicator, pmi-FormatIndicator format indicator, csi-ReportingBand reporting band, codebookConfig configuration, and/or codebookConfig-r16 configuration are the same for the primary and secondary CSI feedback reports; however, one or more of the parameters fed back in a secondary CSI report may have different bitwidth compared with the corresponding parameters fed back in a primary CSI report.

In one example, the CSI-ReportConfig report setting includes only one set of configuration values corresponding to the primary feedback report. The higher-layer parameter codebookType is set to ‘typeII’, and the amplitude coefficient indicator for the codebook corresponding to the secondary CSI report has a bitwidth of 2 bits (e.g., k′1,i(1)∈{0,1, . . . ,3}), compared with a bitwidth of 3 bits for the primary CSI report (e.g., k1,i(1)∈{0,1, . . . ,7}, where k1,i(1) may be defined and the mapping of elements corresponding to k1,i(1) and k′1,i(1) may be non-identical).

In certain embodiments, a codebook is identified by indices reported from one or more CSI reports, wherein the CSI reports may be primary, secondary, or a mixture of both. For instance, the equation used to derive the codebook may include values that are indicated from more than one CSI feedback report.

In one example, if the higher-layer parameter codebookType is set to ‘typeII’ with the value NPSK configured with the higher-layer parameter phaseAlphabetSize set to ‘4’, and the higher-layer parameter subbandAmplitude set to ‘true’, the codebook for 1-layer CSI reporting can take on the form:

$${W}_{{q}_{1} , {q}_{2} , {n}_{1} , {n}_{2} , {p}_{1}^{( 1 )} , {p}_{1}^{( 2 )} , {i}_{2 , 1 , 1}}^{( 1 )} = \frac{1}{\sqrt{{N}_{1} {N}_{2} {{Σ}_{i = 0}^{2 L - 1} ( {p}_{1 , i}^{( 1 )} {p}_{1 , i}^{( 2 )} )}^{2}}} [ \begin{matrix}{\sum }_{i = 0}^{L - 1} {v}_{{m}_{1}^{( i )} , {m}_{2}^{( i )}} {p}_{1 , i}^{( 1 )} {p}_{1 , i}^{( 2 )} {φ}_{1 , i} \\ {\sum }_{i = 0}^{L - 1} {v}_{{m}_{1}^{( i )} , {m}_{2}^{( i )}} {p}_{1 , i + L}^{( 1 )} {p}_{1 , i + L}^{( 2 )} {φ}_{1 , i + L}\end{matrix} ] ,$$

where φ_{1,i}=e^{j2πc}^{_{1,i}}^{^{(t)}}^{/N}^{_{PSK}}·e^{j2πc}^{_{1,i}}^{^{(t+t′)}}^{/N}^{_{PSK}}, and c_{1,i}^{(t)},c_{1,i}^{(t+t′)} represent the phase indicators of non-zero coefficients in beam i reported at the CSI reports transmitted in slots t, t+t′, respectively, which take on the values {0,1, . . . , NPSK−1}.

In some embodiments, one or more of the PMI, CQI, RI, SSBRI, CRI, L1, L1-RSRP, and/or L1-SINR reported in a secondary CSI feedback report may refer to a differential value, computed with respect to the corresponding PMI, CQI, RI, SSBRI, CRI, L1, L1-RSRP, and/or L1-SINR respectively, reported in a prior primary or secondary report.

In one example, the CQI index if the higher-layer parameter cqi-Formatlndicator is set to ‘widebandCQI’ may computed as follows: Wideband CQI value (t+t′)=Wideband CQI index (t)+Differential wideband CQI index (t+t′), wherein the Wideband CQI index (t) represents the CQI index reported in slot t via a primary CSI feedback report, and the Differential wideband CQI index (t+t′) represents the differential wideband CQI index reported in slot t+t′ via a secondary CSI feedback report, with respect to that of the wideband value. The differential wideband CQI index table may take on different values compared with those of the conventional wideband CQI index table.

In various embodiments, one or more of the CSI reports may include one or more indicators of a UE speed, including indicators of the Doppler shift, Doppler spread, the UE speed, and the channel correlation across one or more of space, time, and frequency.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

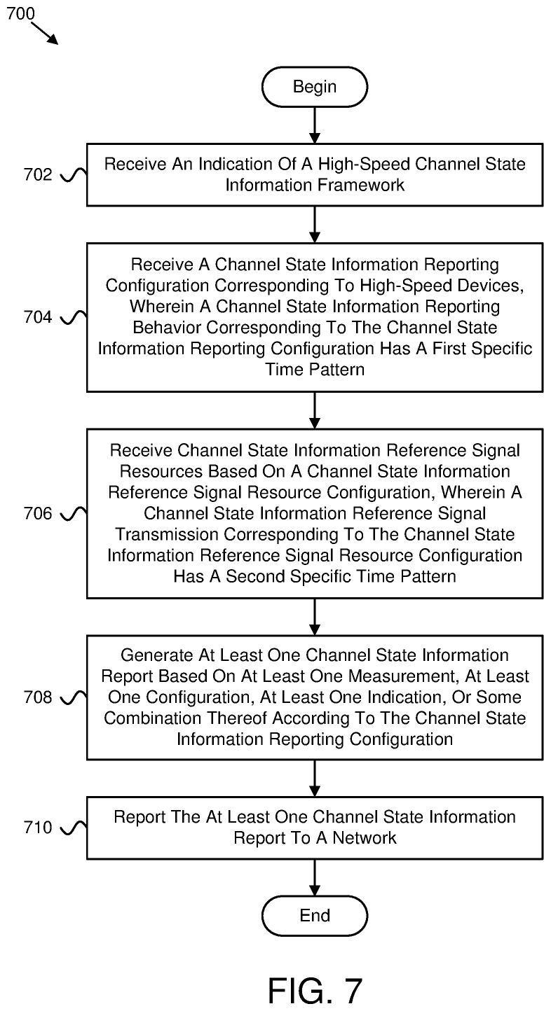

FIG. 7 is a flow chart diagram illustrating one embodiment of a method 700 for reporting channel state information for high speed devices. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 an indication of a high-speed channel state information framework. In some embodiments, the method 700 includes receiving 704 a channel state information reporting configuration corresponding to high-speed devices. A channel state information reporting behavior corresponding to the channel state information reporting configuration has a first specific time pattern. In certain embodiments, the method 700 includes receiving 706 channel state information reference signal resources based on a channel state information reference signal resource configuration. A channel state information reference signal transmission corresponding to the channel state information reference signal resource configuration has a second specific time pattern. In various embodiments, the method 700 includes generating 708 at least one channel state information report based on at least one measurement, at least one configuration, at least one indication, or some combination thereof according to the channel state information reporting configuration. In some embodiments, the method 700 includes reporting 710 the at least one channel state information report to a network.

In certain embodiments, the indication comprises a higher-layer parameter in the channel state information reporting configuration corresponding to configuring high-speed channel state information. In some embodiments, the indication comprises a report quantity indicated in the channel state information reporting configuration corresponding to a Doppler indication, a high-speed indication, or a combination thereof. In various embodiments, the user equipment is configured with two channel state information reporting configurations with different time pattern behaviors.

In one embodiment, a first identifier of a first channel state information reporting configuration of the two channel state information reporting configurations is indicated in a second channel state information reporting configuration of the two channel state information reporting configurations. In certain embodiments, the user equipment is configured with one channel state information reporting configuration configuring two channel state information reference signal resource configurations with different time pattern behaviors. In some embodiments, the first specific time pattern triggers multiple channel state information reports having a non-uniform time interval.

In various embodiments, the second specific time pattern triggers multiple channel state information reference signal transmissions having a non-uniform time interval. In one embodiment, the channel state information reporting configuration, the channel state information reference signal resource configuration, or a combination thereof is configured with a semi persistent time behavior that is deactivated based on a time threshold with respect to an initial time for activating the channel state information reporting configuration. In certain embodiments, the channel state information reporting configuration, the channel state information reference signal resource configuration, or a combination thereof is configured with a semi persistent time behavior that is activated, deactivated, a combination thereof based on an indication from the user equipment.

In some embodiments, the channel state information reporting configuration, the channel state information reference signal resource configuration, or a combination thereof is configured with a semi persistent time behavior that is activated, deactivated, or a combination thereof based on a pre-defined rule. In various embodiments, the pre-defined rule is based on a threshold corresponding to a reference signal received power, a delta to a reference signal received power, a signal to noise ratio, a delta to a signal to noise ratio, a channel quality indicator, a delta to a channel quality indicator, a rank indicator Doppler-related value, a delta to a rank indicator Doppler-related value, or some combination thereof.

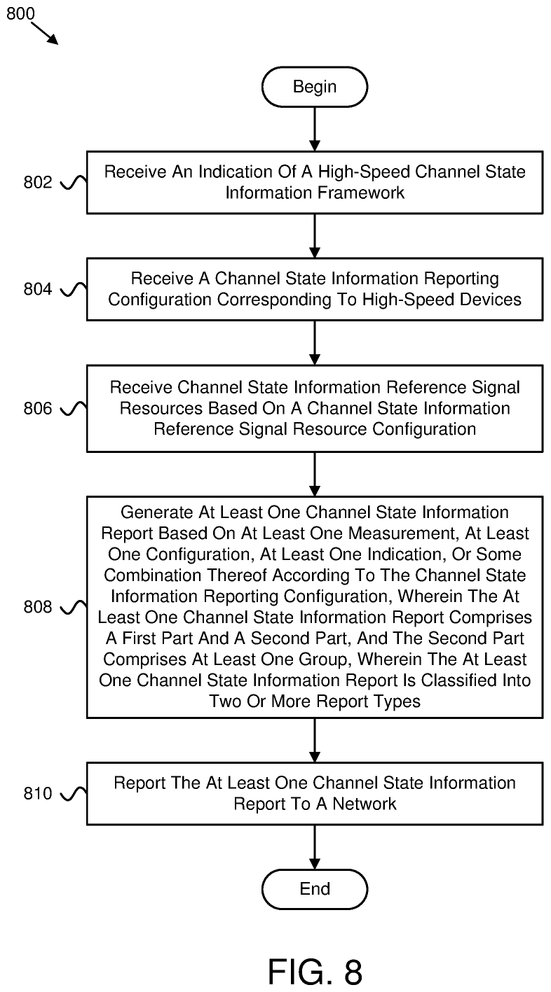

FIG. 8 is a flow chart diagram illustrating another embodiment of a method 800 for reporting channel state information for high speed devices. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 an indication of a high-speed channel state information framework. In some embodiments, the method 800 includes receiving 804 a channel state information reporting configuration corresponding to high-speed devices. In certain embodiments, the method 800 includes receiving 806 channel state information reference signal resources based on a channel state information reference signal resource configuration. In various embodiments, the method 800 includes generating 808 at least one channel state information report based on at least one measurement, at least one configuration, at least one indication, or some combination thereof according to the channel state information reporting configuration. The at least one channel state information report includes a first part and a second part, and the second part includes at least one group. The at least one channel state information report is classified into two or more report types. In some embodiments, the method 800 includes reporting 810 the at least one channel state information report to a network.

In certain embodiments, the at least one channel state information report is classified into a primary channel state information report type and a secondary channel state information report type. In some embodiments, the primary channel state information report type comprises channel state information corresponding to a first subset of two subsets of the channel state information report, and wherein the secondary channel state information report type comprises channel state information corresponding to a second subsequent subset of the two subsets of the channel state information report. In various embodiments, the first subset of the channel state information report comprises the first part of the at least one channel state information report and a first subset of the at least one group of the second part of the channel state information report, and the second subset of the channel state information report comprises a second subset of the at least one group of the second part of the channel state information report.

In one embodiment, the primary channel state information report type comprises a rank indicator, a channel state information resource indicator, a channel quality indicator, a first subset of a precoding matrix indicator, or some combination thereof, and the secondary channel state information report type comprises a second subset of the precoding matrix indicator. In certain embodiments, channel state information report quantities reported in the primary channel state information report type and the secondary channel state information report type are reported with different periodicities. In some embodiments, the secondary channel state information report type is transmitted in a semi-persistent manner, and is deactivated based on signaling, channel conditions, or a combination thereof.

In various embodiments, the primary channel state information report type and the secondary channel state information report type have different configurations for a report quantity, a channel quality information format, a precoding matrix indicator format, a codebook configuration, a report frequency configuration, or a combination thereof. In one embodiment, the differences in configurations between the primary channel state information report type and the secondary channel state information report type are signaled, set by a rule, or are the same but are reported with different bitwidths.

In certain embodiments, one codebook is identified by channel state information included in both of the primary channel state information report type and the secondary channel state information report type. In some embodiments, the primary channel state information report type, the secondary channel state information report type, or a combination thereof comprise Doppler-related information.

In one embodiment, a method of a user equipment comprises: receiving an indication of a high-speed channel state information framework; receiving a channel state information reporting configuration corresponding to high-speed devices, wherein a channel state information reporting behavior corresponding to the channel state information reporting configuration has a first specific time pattern; receiving channel state information reference signal resources based on a channel state information reference signal resource configuration, wherein a channel state information reference signal transmission corresponding to the channel state information reference signal resource configuration has a second specific time pattern; generating at least one channel state information report based on at least one measurement, at least one configuration, at least one indication, or some combination thereof according to the channel state information reporting configuration; and reporting the at least one channel state information report to a network.

In certain embodiments, the indication comprises a higher-layer parameter in the channel state information reporting configuration corresponding to configuring high-speed channel state information.

In some embodiments, the indication comprises a report quantity indicated in the channel state information reporting configuration corresponding to a Doppler indication, a high-speed indication, or a combination thereof.

In various embodiments, the user equipment is configured with two channel state information reporting configurations with different time pattern behaviors.

In one embodiment, a first identifier of a first channel state information reporting configuration of the two channel state information reporting configurations is indicated in a second channel state information reporting configuration of the two channel state information reporting configurations.

In certain embodiments, the user equipment is configured with one channel state information reporting configuration configuring two channel state information reference signal resource configurations with different time pattern behaviors.

In some embodiments, the first specific time pattern triggers multiple channel state information reports having a non-uniform time interval.

In various embodiments, the second specific time pattern triggers multiple channel state information reference signal transmissions having a non-uniform time interval.

In one embodiment, the channel state information reporting configuration, the channel state information reference signal resource configuration, or a combination thereof is configured with a semi persistent time behavior that is deactivated based on a time threshold with respect to an initial time for activating the channel state information reporting configuration.

In certain embodiments, the channel state information reporting configuration, the channel state information reference signal resource configuration, or a combination thereof is configured with a semi persistent time behavior that is activated, deactivated, a combination thereof based on an indication from the user equipment.

In some embodiments, the channel state information reporting configuration, the channel state information reference signal resource configuration, or a combination thereof is configured with a semi persistent time behavior that is activated, deactivated, or a combination thereof based on a pre-defined rule.

In various embodiments, the pre-defined rule is based on a threshold corresponding to a reference signal received power, a delta to a reference signal received power, a signal to noise ratio, a delta to a signal to noise ratio, a channel quality indicator, a delta to a channel quality indicator, a rank indicator Doppler-related value, a delta to a rank indicator Doppler-related value, or some combination thereof.

In one embodiment, an apparatus comprises a user equipment. The apparatus further comprises: a receiver that: receives an indication of a high-speed channel state information framework; receives a channel state information reporting configuration corresponding to high-speed devices, wherein a channel state information reporting behavior corresponding to the channel state information reporting configuration has a first specific time pattern; and receives channel state information reference signal resources based on a channel state information reference signal resource configuration, wherein a channel state information reference signal transmission corresponding to the channel state information reference signal resource configuration has a second specific time pattern; a processor that generates at least one channel state information report based on at least one measurement, at least one configuration, at least one indication, or some combination thereof according to the channel state information reporting configuration; and a transmitter that reports the at least one channel state information report to a network.

In certain embodiments, the indication comprises a higher-layer parameter in the channel state information reporting configuration corresponding to configuring high-speed channel state information.

In some embodiments, the indication comprises a report quantity indicated in the channel state information reporting configuration corresponding to a Doppler indication, a high-speed indication, or a combination thereof.

In various embodiments, the user equipment is configured with two channel state information reporting configurations with different time pattern behaviors.

In one embodiment, a first identifier of a first channel state information reporting configuration of the two channel state information reporting configurations is indicated in a second channel state information reporting configuration of the two channel state information reporting configurations.

In certain embodiments, the user equipment is configured with one channel state information reporting configuration configuring two channel state information reference signal resource configurations with different time pattern behaviors.

In some embodiments, the first specific time pattern triggers multiple channel state information reports having a non-uniform time interval.

In various embodiments, the second specific time pattern triggers multiple channel state information reference signal transmissions having a non-uniform time interval.

In one embodiment, the channel state information reporting configuration, the channel state information reference signal resource configuration, or a combination thereof is configured with a semi persistent time behavior that is deactivated based on a time threshold with respect to an initial time for activating the channel state information reporting configuration.

In certain embodiments, the channel state information reporting configuration, the channel state information reference signal resource configuration, or a combination thereof is configured with a semi persistent time behavior that is activated, deactivated, a combination thereof based on an indication from the user equipment.

In some embodiments, the channel state information reporting configuration, the channel state information reference signal resource configuration, or a combination thereof is configured with a semi persistent time behavior that is activated, deactivated, or a combination thereof based on a pre-defined rule.

In various embodiments, the pre-defined rule is based on a threshold corresponding to a reference signal received power, a delta to a reference signal received power, a signal to noise ratio, a delta to a signal to noise ratio, a channel quality indicator, a delta to a channel quality indicator, a rank indicator Doppler-related value, a delta to a rank indicator Doppler-related value, or some combination thereof.

In one embodiment, a method of a user equipment comprises: receiving an indication of a high-speed channel state information framework; receiving a channel state information reporting configuration corresponding to high-speed devices; receiving channel state information reference signal resources based on a channel state information reference signal resource configuration; generating at least one channel state information report based on at least one measurement, at least one configuration, at least one indication, or some combination thereof according to the channel state information reporting configuration, wherein the at least one channel state information report comprises a first part and a second part, and the second part comprises at least one group, wherein the at least one channel state information report is classified into two or more report types; and reporting the at least one channel state information report to a network.

In certain embodiments, the at least one channel state information report is classified into a primary channel state information report type and a secondary channel state information report type.

In some embodiments, the primary channel state information report type comprises channel state information corresponding to a first subset of two subsets of the channel state information report, and wherein the secondary channel state information report type comprises channel state information corresponding to a second subsequent subset of the two subsets of the channel state information report.

In various embodiments, the first subset of the channel state information report comprises the first part of the at least one channel state information report and a first subset of the at least one group of the second part of the channel state information report, and the second subset of the channel state information report comprises a second subset of the at least one group of the second part of the channel state information report.

In one embodiment, the primary channel state information report type comprises a rank indicator, a channel state information resource indicator, a channel quality indicator, a first subset of a precoding matrix indicator, or some combination thereof, and the secondary channel state information report type comprises a second subset of the precoding matrix indicator.

In certain embodiments, channel state information report quantities reported in the primary channel state information report type and the secondary channel state information report type are reported with different periodicities.

In some embodiments, the secondary channel state information report type is transmitted in a semi-persistent manner, and is deactivated based on signaling, channel conditions, or a combination thereof.

In various embodiments, the primary channel state information report type and the secondary channel state information report type have different configurations for a report quantity, a channel quality information format, a precoding matrix indicator format, a codebook configuration, a report frequency configuration, or a combination thereof.

In one embodiment, the differences in configurations between the primary channel state information report type and the secondary channel state information report type are signaled, set by a rule, or are the same but are reported with different bitwidths.

In certain embodiments, one codebook is identified by channel state information included in both of the primary channel state information report type and the secondary channel state information report type.

In some embodiments, the primary channel state information report type, the secondary channel state information report type, or a combination thereof comprise Doppler-related information.

In one embodiment, an apparatus comprises a user equipment. The apparatus further comprises: a receiver that: receives an indication of a high-speed channel state information framework; receives a channel state information reporting configuration corresponding to high-speed devices; and receives channel state information reference signal resources based on a channel state information reference signal resource configuration; a processor that generates at least one channel state information report based on at least one measurement, at least one configuration, at least one indication, or some combination thereof according to the channel state information reporting configuration, wherein the at least one channel state information report comprises a first part and a second part, and the second part comprises at least one group, wherein the at least one channel state information report is classified into two or more report types; and a transmitter that reports the at least one channel state information report to a network.

In certain embodiments, the at least one channel state information report is classified into a primary channel state information report type and a secondary channel state information report type.

In some embodiments, the primary channel state information report type comprises channel state information corresponding to a first subset of two subsets of the channel state information report, and wherein the secondary channel state information report type comprises channel state information corresponding to a second subsequent subset of the two subsets of the channel state information report.

In various embodiments, the first subset of the channel state information report comprises the first part of the at least one channel state information report and a first subset of the at least one group of the second part of the channel state information report, and the second subset of the channel state information report comprises a second subset of the at least one group of the second part of the channel state information report.

In one embodiment, the primary channel state information report type comprises a rank indicator, a channel state information resource indicator, a channel quality indicator, a first subset of a precoding matrix indicator, or some combination thereof, and the secondary channel state information report type comprises a second subset of the precoding matrix indicator.

In certain embodiments, channel state information report quantities reported in the primary channel state information report type and the secondary channel state information report type are reported with different periodicities.

In some embodiments, the secondary channel state information report type is transmitted in a semi-persistent manner, and is deactivated based on signaling, channel conditions, or a combination thereof.

In various embodiments, the primary channel state information report type and the secondary channel state information report type have different configurations for a report quantity, a channel quality information format, a precoding matrix indicator format, a codebook configuration, a report frequency configuration, or a combination thereof.

In one embodiment, the differences in configurations between the primary channel state information report type and the secondary channel state information report type are signaled, set by a rule, or are the same but are reported with different bitwidths.

In certain embodiments, one codebook is identified by channel state information included in both of the primary channel state information report type and the secondary channel state information report type.

In some embodiments, the primary channel state information report type, the secondary channel state information report type, or a combination thereof comprise Doppler-related information.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method at a user equipment (UE), the method comprising:
receiving an indication of a high-speed channel state information (CSI) framework;
receiving a CSI reporting configuration corresponding to high-speed devices;
receiving CSI reference signal (RS) (CSI-RS) resources based on a CSI-RS resource configuration;
generating at least one CSI report based on at least one measurement, at least one configuration, at least one indication, or a combination thereof according to the CSI reporting configuration, wherein the at least one CSI report comprises a first part and a second part, and the second part comprises at least one group, wherein the at least one CSI report is classified into two or more report types; and
reporting the at least one CSI report to a network.

2. The method of claim 1, wherein the at least one CSI report is classified into a primary CSI report type and a secondary CSI report type.

3. The method of claim 2, wherein the primary CSI report type comprises CSI corresponding to a first subset of two subsets of the CSI report, and wherein the secondary CSI report type comprises CSI corresponding to a second subsequent subset of the two subsets of the CSI report.

4. The method of claim 3, wherein the first subset of the CSI report comprises the first part of the at least one CSI report and a first subset of the at least one group of the second part of the CSI report, and the second subset of the CSI report comprises a second subset of the at least one group of the second part of the CSI report.

5. The method of claim 2, wherein the primary CSI report type comprises a rank indicator (RI), a CSI resource indicator (CRI), a channel quality indicator (CQI), a first subset of a precoding matrix indicator (PMI), or a combination thereof, and the secondary CSI report type comprises a second subset of the PMI.

6. The method of claim 2, wherein CSI report quantities reported in the primary CSI report type and the secondary CSI report type are reported with different periodicities.

7. The method of claim 2, wherein the secondary CSI report type is transmitted in a semi-persistent manner, and is deactivated based on signaling, channel conditions, or a combination thereof.

8. The method of claim 2, wherein the primary CSI report type and the secondary CSI report type have different configurations for a report quantity, a channel quality information (CQI) format, a precoding matrix indicator (PMI) format, a codebook configuration, a report frequency configuration, or a combination thereof.

9. The method of claim 8, wherein the differences in configurations between the primary CSI report type and the secondary CSI report type are signaled, set by a rule, or are the same but are reported with different bitwidths.

10. The method of claim 2, wherein one codebook is identified by CSI included in both of the primary CSI report type and the secondary CSI report type.

11. The method of claim 2, wherein the primary CSI report type, the secondary CSI report type, or a combination thereof comprise Doppler-related information.

12. An apparatus comprising:
a processor; and
a memory coupled to the processor, the memory comprising instructions executable by the processor to cause the apparatus to:
receive an indication of a high-speed channel state information (CSI) framework;
receive a CSI reporting configuration corresponding to high-speed devices;
receive CSI reference signal (RS) (CSI-RS) resources based on a CSI-RS resource configuration;
generate at least one CSI report based on at least one measurement, at least one configuration, at least one indication, or a combination thereof according to the CSI reporting configuration, wherein the at least one CSI report comprises a first part and a second part, and the second part comprises at least one group, wherein the at least one CSI report is classified into two or more report types; and
report the at least one CSI report to a network.

13. The apparatus of claim 12, wherein the at least one CSI report is classified into a primary CSI report type and a secondary CSI report type.

14. (canceled)

15. An apparatus comprising:
a processor; and
a memory coupled to the processor, the memory comprising instructions executable by the processor to cause the apparatus to:
transmit an indication of a high-speed channel state information (CSI) framework;
transmit a CSI reporting configuration corresponding to high-speed devices;
transmit CSI reference signal (RS) (CSI-RS) resources based on a CSI-RS resource configuration; and
receive at least one CSI report, wherein the at least one CSI report is determined based on at least one measurement, at least one configuration, at least one indication, or a combination thereof according to the CSI reporting configuration, the at least one CSI report comprises a first part and a second part, the second part comprises at least one group, and the at least one CSI report is classified into two or more report types.

16. The method of claim 1, wherein the CSI-RS resource configuration configures two CSI-RS resource configurations with different time pattern behaviors.

17. The apparatus of claim 13, wherein the primary CSI report type comprises CSI corresponding to a first subset of two subsets of the CSI report, and wherein the secondary CSI report type comprises CSI corresponding to a second subsequent subset of the two subsets of the CSI report.

18. The apparatus of claim 17, wherein the first subset of the CSI report comprises the first part of the at least one CSI report and a first subset of the at least one group of the second part of the CSI report, and the second subset of the CSI report comprises a second subset of the at least one group of the second part of the CSI report.

19. The apparatus of claim 13, wherein the primary CSI report type comprises a rank indicator (RI), a CSI resource indicator (CRI), a channel quality indicator (CQI), a first subset of a precoding matrix indicator (PMI), or a combination thereof, and the secondary CSI report type comprises a second subset of the PMI.

20. The apparatus of claim 13, wherein CSI report quantities reported in the primary CSI report type and the secondary CSI report type are reported with different periodicities.

21. The apparatus of claim 13, wherein the secondary CSI report type is transmitted in a semi-persistent manner, and is deactivated based on signaling, channel conditions, or a combination thereof.
